(19) United States
(12) Patent Application Publication
(10) Pub. No.: US 2010/0107066 A1
(43) Pub. Date: Apr. 29, 2010

(54) SCROLLING FOR A TOUCH BASED GRAPHICAL USER INTERFACE

(75) Inventors: Kari Hiitola, Tampere (FI); John Rieman, Helsinki (FI); Harri Heine, Tampere (FI); Jyrki Yli-Nokari, Saratoga, CA (US)

Correspondence Address: Perman & Green, LLP, 99 Hawley Lane, Stratford, CT, 06614, US

(73) Assignee: NOKIA CORPORATION, Espoo (FI)

(21) Appl. No.: 12/258,766

(22) Filed: Oct. 27, 2008

(51) Int. Cl. G06F 3/01; G06F 3/048

(52) U.S. Cl. 715/702; 715/787

(57) ABSTRACT

A user interface for a device including display means for displaying a portion of a full content in an application area and control means. The control means are configured for displaying a scrollbar along an edge of the application area, wherein at least a portion of the scrollbar is non-linearly mapped to at least a portion of the full content. The control means are also for receiving touch input originating in the scrollbar and updating the displayed portion according to the received touch input, wherein the full content is panned in a direction corresponding to either a direction of the touch input or a location of the touch input in relation to the mapped location of the displayed portion on the scrollbar.

### BACKGROUND

1. Field

The present application relates to an improved scrollbar, and in particular to a user interface, a device and a method for improving scrolling on a touch based user interface.

2. Brief Description of Related Developments

More and more electronic devices such as mobile phones, MP3 players, Personal Digital Assistants (PDAs) are being configured with Graphical User interfaces (GUI) in the form of touch displays.

One problem with user interfaces with small displays arises when the content to be viewed is too large to fit on the display. Commonly only a portion of the content is then shown and a scrollbar is arranged on the display. The user can then pan the underlying content by moving the scrollbar. However, the use of scrollbars in touch based user interfaces can be problematic as sliding the elevator in the scrollbar down moves the image up, whereas moving the image by a dragging action on the touch UI moves the content in the dragging direction. This creates an inconsistency between the two command options that a user may find difficulties understanding. Reversing the direction of the scrollbar would solve this problem but make the scrollbars on touch UIs inconsistent with scrollbars on other devices such as personal computers.

Such inconsistencies will produce errors and discomfort when a user tries to use the system.

### SUMMARY

On this background, it would be advantageous to provide a user interface, a device, a computer-readable medium and a method that overcomes or at least reduces the drawbacks indicated above by providing a user interface, a device, a computer-readable medium and a method according to the claims.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 2 in accordance with the present application,

FIG. 4 is a plane view of a device according to an embodiment,

FIG. 5 is a schematic view of a content to be displayed in an application area according to an embodiment, and

FIG. 6 is a flow chart describing a method according to an embodiment of the application.

### DETAILED DESCRIPTION OF THE DRAWINGS

In the following detailed description, the device, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

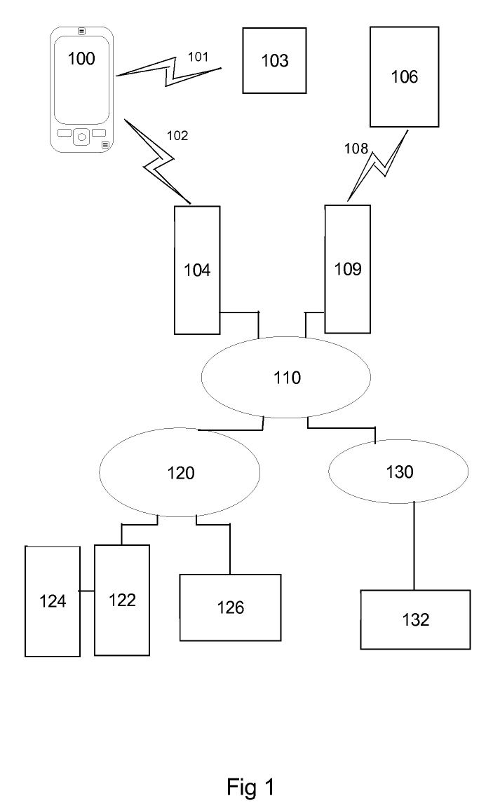

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency, RF links 102, 108 via base stations 104, 109. The mobile telecommunications network 110 may be in compliance with any commercially available mobile telecommunications standard, such as Group Spéciale Mobile, GSM, Universal Mobile Telecommunications System, UMTS, Digital Advanced Mobile Phone system, D-AMPS, The code division multiple access standards CDMA and CDMA2000, Freedom Of Mobile Access, FOMA, and Time Division-Synchronous Code Division Multiple Access, TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

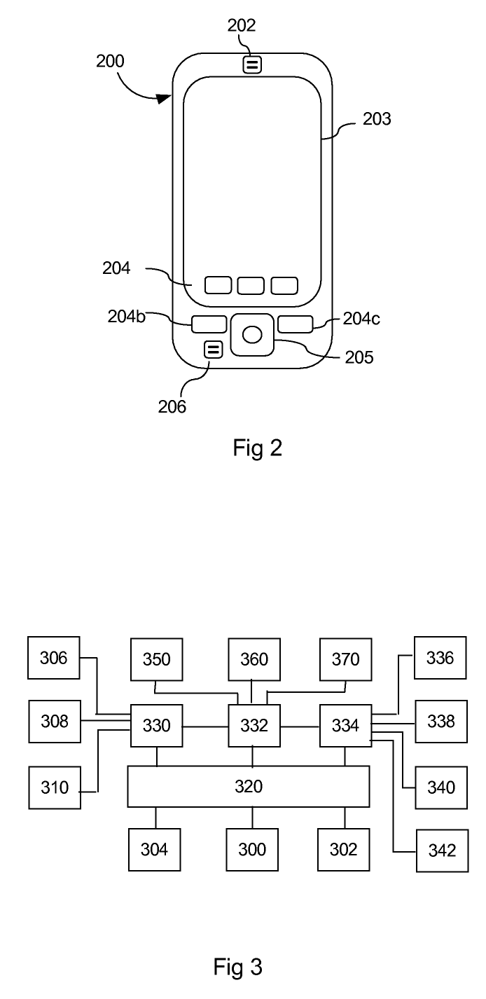

An embodiment 200 of the mobile terminal 100 is illustrated in more detail in FIG. 2. The mobile terminal 200 comprises a speaker or earphone 202, a microphone 206, a main or first display 203 being a touch display. As is commonly known a touch display may be arranged with virtual keys 204. The device is further arranged in this embodiment with a set of hardware keys such as soft keys 204b, 204c and a joystick 205 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM) memory, Read Only memory (ROM) memory, Electrically Erasable Programmable Read-Only Memory (EEPROM) memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the touch display 336/203, and the keys 338/204, 205 as well as various other Input/Output devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

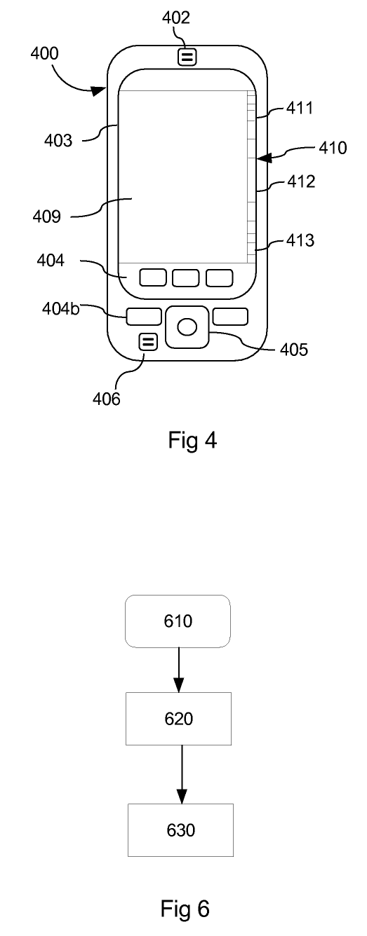

FIG. 4 shows an embodiment of the teachings herein which device in this embodiment is a mobile telephone 400 but it should be understood that this application is not limited to mobile phones, but can find use in other devices having a touch based user interface such as personal digital assistants (PDA), laptops, media players, navigational devices, game consoles, personal organizers and digital cameras.

The mobile telephone 400 has a display 403 which shows an application area 409. The application area 409 is arranged with a scrollbar 410. As indicated by the portions 411 to 413 the scrollbar is divided in smaller portions. One portion 412 corresponds to what is currently being displayed in the application area 409 and the other portions 411 and 413 correspond to what is currently not able to fit in the application area 409.

It should be noted that these portions are not discrete portions, but the effect is continuous over the scrollbar. The divided portions are purely for illustrative purposes.

The scrollbar 410 is arranged to show a compressed image of the full content to be displayed. The compression is non-linear and often referred to as being of a Fisheye type. This means that the portion of the full content currently being displayed is given or is mapped to a larger portion of the scrollbar 410 than the portions that are currently not being displayed.

This makes it easy for a user to see what portion of the full content is being currently displayed and where it is located in the full content without having an elevator element in the scrollbar.

The full content is scrolled by the user touching the scrollbar in the area 412 corresponding to the currently displayed portion of the full content and sliding this portion along the scrollbar. The displayed content is moved in the same direction as the sliding motion. This provides a user with an intuitive coupling of the scrollbar and the displayed content. Scrolling by sliding the area 412 corresponding to the currently displayed content is linear in that the full content is panned in the same speed as the sliding. While the scrolling is in action the scrollbar 410 is updated continuously.

A touch or a tap outside the area corresponding to the currently displayed content, i.e. outside the first portion 412, will result in that the application area 409 displays a portion of the full content whose middle point corresponds to the position on the scrollbar. This has the effect that the further away from the area 412 corresponding to the currently displayed portion the user taps or touches the longer the scroll jump is.

In one embodiment the first portion 412 is fixed on the scrollbar. This has the advantage of further differentiating the improved scrollbar of the teachings herein with a traditional scrollbar thus instructing a user to operate the scrollbar differently in an intuitive and sublime manner.

In this embodiment the scrolling is achieved by a sliding gesture within the first portion 412. While the sliding gesture is maintained within the first portion 412 the speed of scrolling is constant. Should the sliding gesture leave the first portion 412 and continue in either of the other portions 411 or 413 the scrolling speed is increased. In one embodiment the speed is maintained even if the sliding gesture goes outside the first portion 412.

In one embodiment the scrolling is continued for as long as there is contact between the item (finger or stylus) that initiated the sliding gesture and the touch display even if the sliding movement has stopped.

In one embodiment the first portion 412 moves up and down the scrollbar 410 as the user scrolls the page.

In one embodiment the user interface of the device is arranged to scroll the content being displayed at a speed that corresponds to the non-linear distance from the first portion 412 corresponding to the portion currently being displayed in the application area 409. If a user thus makes a sliding motion in the scrollbar in either of the other portions 411 or 413 the scroll speed is determined according to the distance from the first portion 412. Thus to make a fast scroll a user can make a sliding gesture in the scrollbar close to one of the edges.

In one embodiment the scroll speed is determined corresponding to the starting position of the sliding action. In one embodiment the scrolling speed varies according to the distance from the edges.

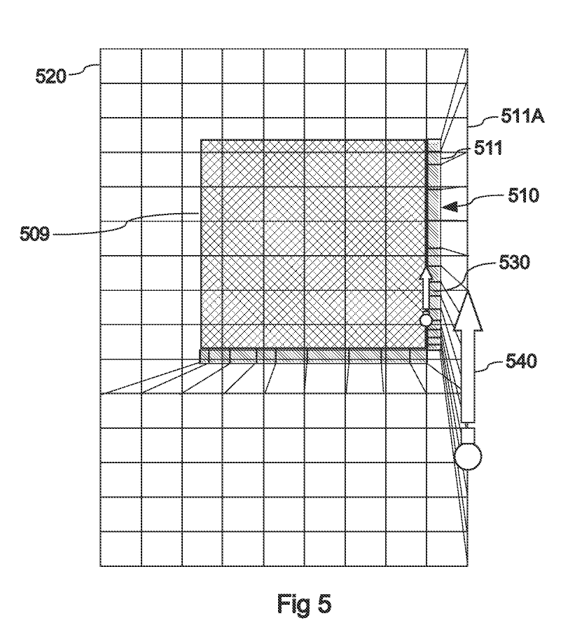

FIG. 5 shows a schematic view of a content 520 and an application area 509 which has a scrollbar 510. As is indicated by the lines 521 the various portions 511 of the scrollbar corresponds to portions 511A of the full content, where the size of the scrollbar portions 511 are not of the same size, the portions 511A of the full content is. This provides a non-linear distribution.

As is also indicated by the arrows 530 and 540 a sliding gesture in the scrollbar 530 outside the first portion (412) results in a correspondingly larger portion of the full content 540 being scrolled.

By providing a compressed image of the full content a user is given an indication of what portion of the full content he is currently viewing and how much else there is to be viewed. In FIG. 5 the first portion (412) is not fixed, but it should be understood that any combination of having a fixed first portion or a movable one with the other features disclosed herein is part of the teachings of this application.

In one embodiment the user interface is arranged to not move the page as the scrollbar is touched, only when a sliding gesture is detected.

In one embodiment only a portion of a traditional scrollbar is configured to act as a scrollbar according to the teachings herein. That is, only a portion of the scrollbar and the full content have a non-linear mapping.

FIG. 6 shows a flowchart of a method according to the teachings herein. In a first step 610 a content to be displayed on a touch display is mapped to a scrollbar non-linearly and a portion of the full content is displayed in an application area. In a second step 620 the scrollbar is displayed along an edge of the application area which is displayed on the touch display. As a touch input is received in the scrollbar it is determined the content being displayed in the application is updated by the full content being panned in a direction according to the touch input, step 630, and the updated portion is displayed.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in personal digital assistants (PDA), laptops, media players, navigational devices, game consoles, personal organizers and digital cameras or any other device designed for a touch based user interface.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user is provided with a scrollbar that provides a consistent association of input gesture direction and resulting movement while not being confusing with regards to traditional scrollbars.

Another exemplary advantage of the teaching of the present application is that the improved scrollbar solves the problem of inconsistent scrolling direction between page and scroll bar. This allows the scroll bar and the displayed image to remain close together, since targeting errors (dragging page instead of scroll bar) aren't so severe.

Another exemplary advantage of the teaching of the present application is that the improved scrollbar allows user to scroll the page even if the current view is an active element on the page which can't be touched without causing unintended action, e.g. a scrolling list.

Another exemplary advantage of the teaching of the present application is that the improved scrollbar hint at its function to users who know traditional scroll bars, while slightly different appearance (position and appearance of the scroll bar) helps users avoid confusion with traditional scrollbars.

Another exemplary advantage of the teaching of the present application is that the improved scrollbar's first portion gives an indication of the zoom level currently employed for displaying the content or how much of the full content is currently not displayed.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. A user interface for a device having a controller and a display configured to display a portion of a full content in an application area, wherein said controller is configured to:
display a scrollbar along an edge of said application area wherein at least a portion of said scrollbar is non-linearly mapped to at least a portion of said full content,
receive touch input originating in said scrollbar and
updating said displayed portion according to the received touch input, wherein said full content is panned in a direction corresponding to either a direction of the touch input or a location of the touch input in relation to the mapped location of the displayed portion on the scrollbar.

2. A user interface according to claim 1, wherein said controller is configured to completely map said full content to said scrollbar.

3. A user interface according to claim 1, wherein said controller is configured to map said full content to said scrollbar so that content to be displayed is mapped to a first portion which has a comparatively larger portion of the scrollbar than the other mapped portions of the full content.

4. A user interface according to claim 3, wherein said controller is configured to receive touch input outside said first portion and in response thereto re-map the full content to the scrollbar so that the position of the full content corresponding to the location of the touch input in the scrollbar is mapped to the middle of the first portion.

5. A user interface according to claim 3, wherein said controller is configured to receive touch input representing a sliding gesture originating in the first portion and in response thereto update the displayed portion of the full content.

6. A user interface according to claim 5, wherein said controller is configured to increase a scrolling speed if said sliding gesture represented by said received touch input is continued outside said first portion.

7. A user interface according to claim 3, wherein said controller is configured to display said first portion on said scrollbar in accordance to touch input received representing a scrolling command wherein said first portion is moved along said scrollbar.

8. A user interface according to claim 1, wherein said controller is configured to update said displayed portion when said received touch input represents a sliding gesture.

9. A user interface for a device comprising display means for displaying a portion of a full content in an application area and control means, wherein said control means are configured for:
displaying a scrollbar along an edge of said application area, wherein at least a portion of said scrollbar is non-linearly mapped to at least a portion of said full content,
receiving touch input originating in said scrollbar and
updating said displayed portion according to the received touch input, wherein said full content is panned in a direction corresponding to either a direction of the touch input or a location of the touch input in relation to the mapped location of the displayed portion on the scrollbar.

10. A device configured to implement or comprising a user interface according to claim 1.

11. A method for scrolling displayed content in a device comprising a display and a controller, said method comprising:
displaying a portion of a full content in an application area,
non-linearly mapping at least a portion of a scrollbar to at least a portion of said full content,
displaying said scrollbar along an edge of said application area,
receiving touch input originating in said scrollbar and
updating said displayed portion according to the received touch input, wherein said full content is panned in a direction corresponding to either a direction of the touch input or a location of the touch input in relation to the mapped location of the displayed portion on the scrollbar.

12. A method according to claim 11 further comprising completely mapping said full content to said scrollbar.

13. A method according to claim 11 further comprising mapping said full content to said scrollbar so that content to be displayed is mapped to a first portion which has a comparatively larger portion of the scrollbar than the other mapped portions of the full content.

14. A method according to claim 13 further comprising receiving touch input outside said first portion and in response thereto
re-mapping the full content to the scrollbar so that the position of the full content corresponding to the location of the touch input in the scrollbar is mapped to the middle of the first portion.

15. A method according to claim 13 further comprising receiving touch input representing a sliding gesture originating in the first portion and in response thereto updating the displayed portion of the full content.

16. A method according to claim 15 further comprising increasing a scrolling speed if said sliding gesture represented by said received touch input is continued outside said first portion.

17. A method according to claim 13 further comprising displaying said first portion on said scrollbar in accordance to touch input received representing a scrolling command wherein said first portion is moved along said scrollbar.

18. A method according to claim 1 further comprising updating said displayed portion when said received touch input represents a sliding gesture.

19. A device configured to implement a method according to claim 11.

20. A computer readable medium including at least computer program code for controlling a user interface comprising a display and a controller, said computer readable medium comprising:
software code for displaying a portion of a full content in an application area,
software code for non-linearly mapping at least a portion of a scrollbar to at least a portion of said full content,
software code for displaying said scrollbar along an edge of said application area,
software code for receiving touch input originating in said scrollbar and
software code for updating said displayed portion according to the received touch input, wherein said full content is panned in a direction corresponding to either a direction of the touch input or a location of the touch input in relation to the mapped location of the displayed portion on the scrollbar.

21. A device incorporating and implementing a computer readable medium according to claim 21.

22. A device according to claim 10, wherein said device is a personal digital assistant, laptop, media player, navigational device, game console, personal organizer or digital camera.
